(19) United States
(12) Patent Application Publication
(10) Pub. No.: US 2006/0026755 A1
(43) Pub. Date: Feb. 9, 2006

(54) Patient lift with integrated foot push pad

(76) Inventors: Colin C. Bain, Longmont, CO (US); Nigel Heales, Holmer Lake (GB); David Genske, Westminster, CO (US)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/911,924

(22) Filed: Aug. 5, 2004

(51) Int. Cl. A61G 7/14

(52) U.S. Cl. 5/86.1; 5/925

(57) ABSTRACT

A patient lift comprises a base and a foot push pad integrated with the base. The foot push pad provides a high-friction surface to reduce risk that an operator's foot will slip off the base.

### BACKGROUND OF INVENTION

This invention relates in general to hoisting equipment and more particularly, to a portable lifting apparatus for lifting and moving incapacitated persons.

Lifting devices are well known. Such devices typically include a base, a mast extending upwardly from the base, and a boom extending forwardly from the mast. The boom generally supports a cradle by which the patient can be completely suspended from the lifting device. Rollers depending from the base enable the device and thus the patient to be moved.

Ease in moving a patient is critical to the function of the lifting device. It is well known to provide lift devices with handles that may be grasped by an operator to move or manipulate the lifting device when moving a patient. In addition, the operator of a conventional lift may put his or her foot on the lift base when moving or manipulating the lift. Force from the foot gives the operator extra leverage and/or control over the lift. However, the operator's foot is prone to slip off the base.

A patient lift is needed that reduces the risk that the operator's foot will slip off the base when using the operator's foot against the base to give the operator extra leverage and/or control when moving or manipulating the lift.

### SUMMARY OF INVENTION

The present invention is directed towards a patient lift that meets the foregoing needs. The lift comprises a base and a foot push pad integrated with the base. The foot push pad provides a high-friction surface to reduce risk that an operator's foot will slip off the base.

Various objects and advantages of this invention will become apparent to those skilled in the art from the following detailed description of the preferred embodiment, when read in light of the accompanying drawings.

### BRIEF DESCRIPTION OF DRAWINGS

FIG. 1 is a front perspective view of a lift according to a preferred embodiment of the invention.

FIG. 2 is a rear perspective view of the lift shown in FIG. 1.

FIG. 3 is a top plan view of the lift shown in FIGS. 1 and 2 folded for transportation and storage.

FIG. 4 is an enlarged, rear perspective view of the foot push pad of the lift shown in FIGS. 1 and 2.

FIG. 5 is a rear view in elevation of the foot push pad shown in FIG. 4.

FIG. 6 is a top plan view in elevation of the foot push pad shown in FIGS. 4 and 5.

### DETAILED DESCRIPTION

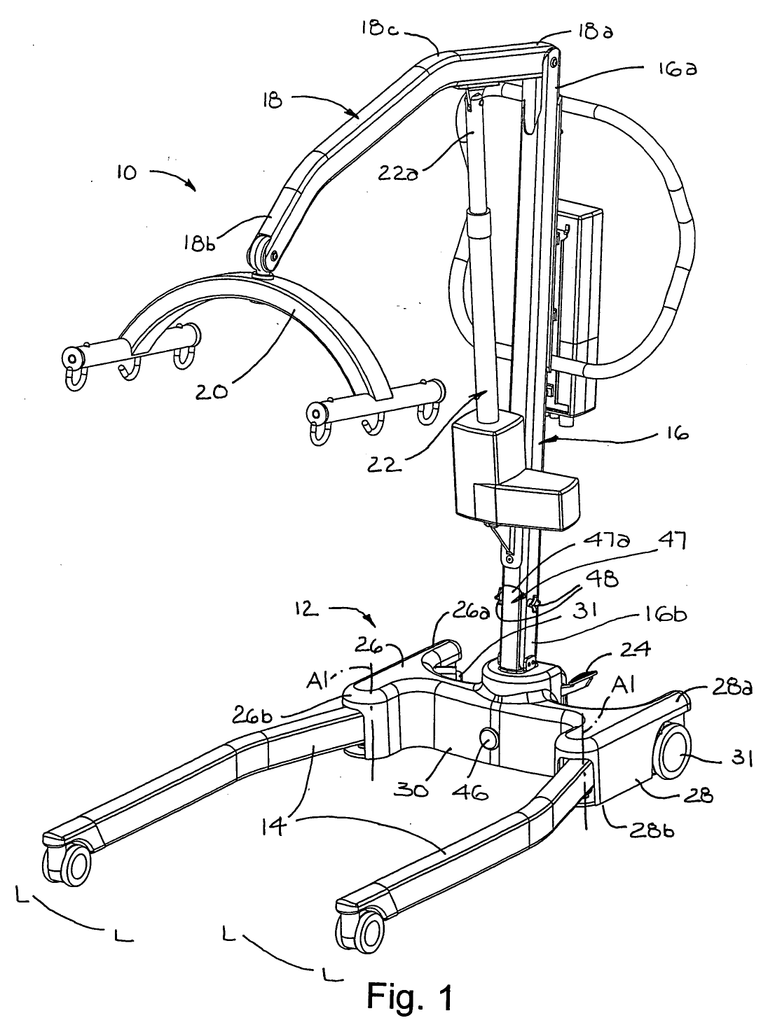

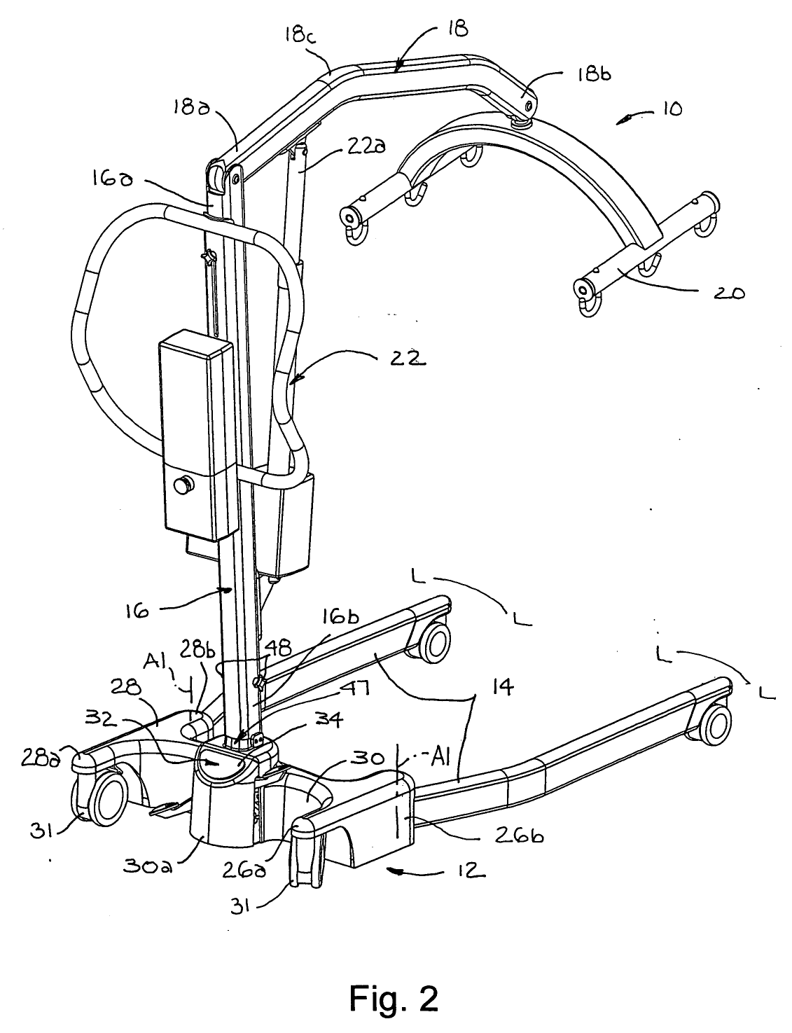

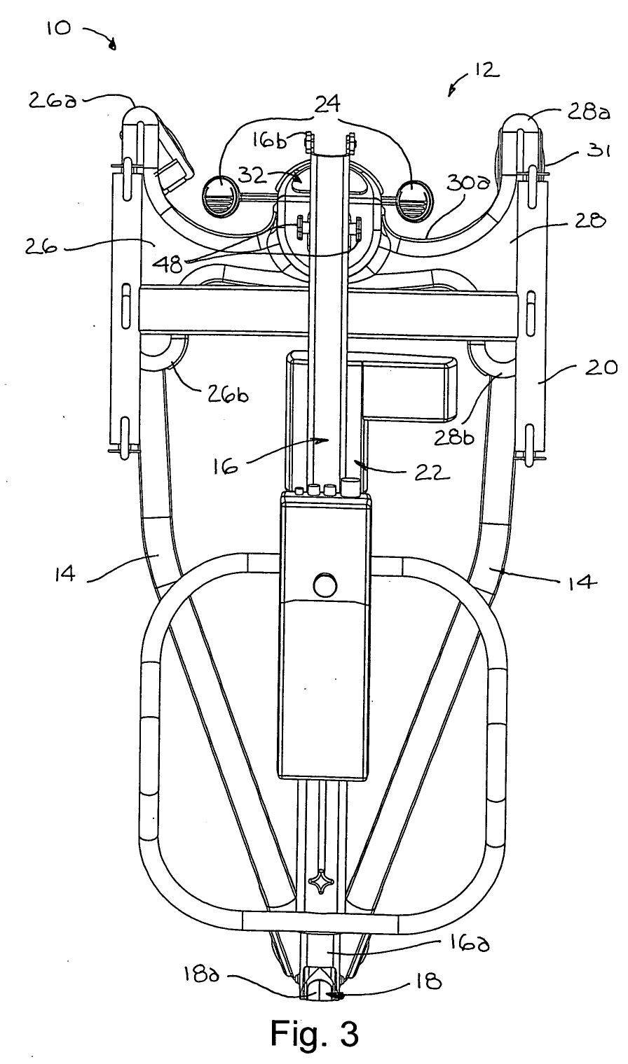

Referring now to the drawings, there is illustrated in FIGS. 1 and 2 a portable lift, generally indicated at 10. The lift preferably includes a base 12, a pair of displaceable support legs 14 extending horizontally from the base 12, a mast 16 extending vertically from the base 12, and a boom 18 extending from an upper end 16a of the mast 16. The mast 16 is preferably not telescopic, but rather a single piece. The boom 18 is pivotally connected at one end 18a to the mast 16, and the boom 18 has a cradle 20 at its other end 18b for lifting patients (not shown). An actuator 22 is mounted part way up the height of the mast 16, and is connected at its far end 22a to an intermediate portion 18c of the boom 18 so that actuation of the actuator 22 pivots the boom 18 relative to the mast 16. During operation, the legs 14 can be opened and closed to (e.g., along the lines L-L) accommodate the operating needs of the lift 10. The opening and closing motion is accomplished by operation of a foot pedal 24. The lift 10 may be folded, as shown in FIG. 3, so that the lift 10 may be easily transported and stored. To fold the lift 10, the legs 14 are closed together, the boom 18 is pivoted down so that it is substantially parallel with the mast 16. Then, the mast 16, with the downward pivoted boom 18, is pivoted down toward or onto the base 12 to assume a position nearly parallel with the legs 14 and the ground or other support surface.

The illustrated base 12 is generally H-shaped, having left and right sides 26, 28 oriented in a forward/rearward direction, and having a central connecting portion 30 extending laterally between the sides 26, 28. Each side 26, 28 has a rearward end 26a, 26a from which a caster wheel 31 is mounted for rotation. A forward end 26b, 28b of each side 26, 28 provides a mounting point for a legs 14, wherein the legs 14 may be rotatable on a vertical axis A1 for opening and closing relative to each other.

The foot pedal 24 controls the opening and collapsing of the legs 14. The legs 14 preferably operate in unison so that when one leg 14 opens or closes, the other leg 14 opens or closes as well. The lift may include a locking mechanism (not shown) to prevent the legs 14 from inadvertently closing or otherwise moving when the lift 10 is carrying a patient. The foot pedal 24 is actuated by the foot action of the lift operator. The legs 14 preferably operate in a first range of motion for a lifting and moving operation, and a second range of motion for compactly folding the lift 10. Disengagement of the legs 14 from the locking mechanism may be effected by pulling a hand-operated, spring-loaded control knob 46. When disengaged from the locking mechanism, the legs 14 are free to be compactly folded. The legs 14 may be re-engaged with the mechanical controller to hold the legs 14 in the folded position for secure placement of the legs 14 when transporting and storing the lift 10. Alternatively, the legs 14 may remain disengaged from the mechanical controller and may be otherwise retrained, such as by tethers, when transporting and storing the lift 10. The control knob 46 is preferably hand operated, as are the legs 14 when disengaged from the mechanical controller. In this way, no tools are required to fold the lift 10. It is also preferable that the major parts of the lift 10 be moved or folded without tools, including the legs 14, the mast 16 and the boom 18.

The mast 16 is attached to the lift base 12 preferably by means of a short vertical mast support post 47 that is fixed with respect to the base 12. The mast 16 is pivotally mounted at a top end 47a of the support post 47, and a connection holding the mast 16 from pivoting with respect to the support post 47 is a hand-operable control knob 48. In the illustrated embodiment, the mast 16 can be lifted and pivoted with respect to the support post 47 for folding without requiring tools for disengagement of the mast 16. When the lift 10 is folded for transporting or storing, a lower end 16b of the mast 16, having been pivoted relative to the support post 47, preferably protrudes rearward with respect to the entire lift 10 as shown in FIG. 5. In this way, when the folded lift 10 is set on end, the lift 10 rests in a three-point vertical stance. In this stance, the lift 10 may be entirely supported by the rearward ends 26a, 28a of the left and right sides 26, 28 of the base 12 and by the exposed lower end 16b of the pivoted mast 16. The length of the support post 47 the distance between the exposed lower end 16b of the mast 16 and a plane connecting the two rearward ends 26a, 28a of the sides 26, 28 of the base 12. The advantage of this lift 10 over conventional lifts is that the third leg or point of the three point stance is separated far enough away from the other two legs or points (the rearward end 26a, 28a of each side 26, 28 of the base 12) for good stability.

A novel feature of the lift 10 is a foot push pad 32, as shown in FIG. 2, that is integrated with a rear end 30a (i.e., facing the operator) of the central connecting portion 30 of the base 12. That is to say, the foot push pad 32 unified or united with the lift 10, or is brought together with the base 12 so as to be a part of the lift 10 as a whole. The integrated foot push pad 32 provides a good place for the operator to put his or her foot when moving or manipulating the lift, where force from the foot gives the operator extra leverage and/or control.

The foot push pad 32 has an angled face suitable for the operator to apply foot pressure when moving or manipulating the lift 10. Force from the operator's foot gives the operator extra leverage and/or control when moving or manipulating the lift 10. With the push pad 32 integrated into the base 12, and having a high-friction surface, the operator's foot will be less likely to slip off the base 12 than if no foot push pad were provided.

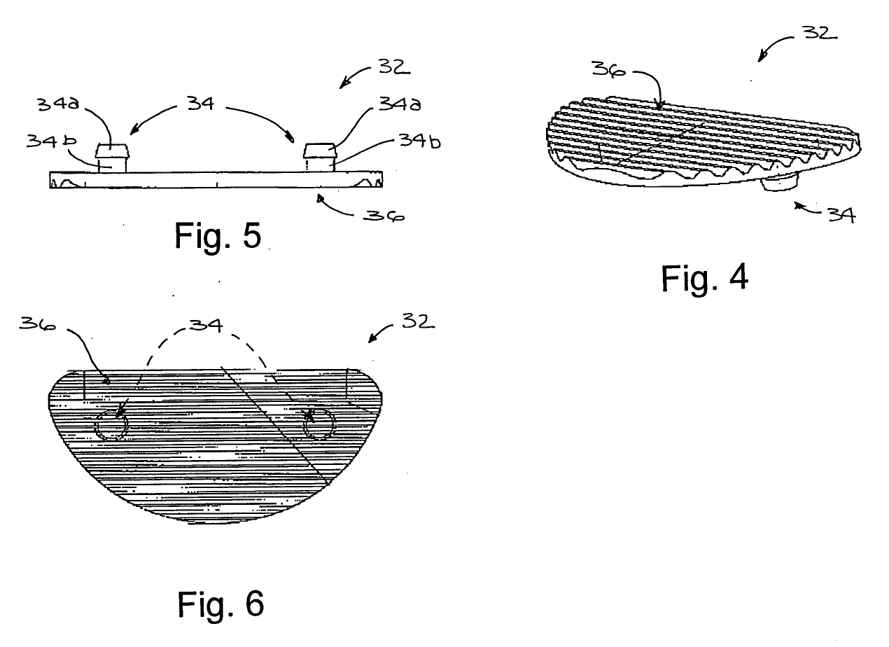

An example of a foot push pad 32 according to the invention is shown in FIGS. 4-6. The foot push pad 32 is preferably formed from a heavy duty material, such as but not limited to ethylene propylene diene monomer (or Terpolymer) (EPDM) rubber, although the invention may be practiced with other suitable materials, including but not limited to vinyl. EPDM rubber is a rubber material having principal components consisting of ethylene and propylene compounds. A flexible rubber matrix forms when a small amount of diene is added to the mix. EPDM rubber is available reinforced or unreinforced. It is also available in either a cured (vulcanized) or uncured (non-vulcanized) state. Vulcanized EPDM is the most common. The frictional value of EPDM rubber is 0.53μ. It should be appreciated that other suitable materials may have other frictional values that suitable for practicing the invention.

The foot push pad 32 may be attached to the base 12 in any suitable manner. However, in accordance with a preferred embodiment of the invention, the foot push pad 32 may have one of more knobs 34 extending from the bottom thereof. The knobs 34 are adapted to engage mating holes (not shown) in the base 12. Each knob 34 has a button or head 34a that is slightly larger than the mating hole, and may be tapered so as to be pass through the hole in one direction and defines a shoulder that resists movement of the head 34a through the hole in an opposing direction. In this way, the knob 34 may be forced through the hole and hold the foot push pad 32 tightly against the base 12. The length of the stud 34b between the head 34a and the bottom of the foot push pad 32 should allow the foot push pad 32 to be held tightly against the base 12. For example, the knob 34 could have an overall length of about 7.5 mm, with a head 34a having a greater dimensional width of about 9.7 mm, with a 30 degree angle measure from taper to taper (or about a 15 degree taper). The stud 34b could have a length of about 4 mm. It should be appreciated that other means may be provided for attaching the foot push pad to the base, including other mechanical fasteners and non-mechanical fasteners, such as but not limited to an adhesive, such as an a thick acrylic adhesive applied to the bottom of the foot push pad 32. Mechanical and non-mechanical fasteners may be used together so that one fastener supplements the other.

The foot push pad 32 is preferably oriented as an angle of about 45 degrees, which is a suitable angle for the operator to apply foot pressure when moving or manipulating the lift 10. Other angles may be suitable but the angle should permit the operator to apply force from the operator's foot to give the operator extra leverage and/or control when moving or manipulating the lift 10.

The top of the foot push pad 32 preferably has a finished surface 36, such as a convex diamond finish. The surface is most preferably ribbed, or includes a plurality ridges, as shown in the drawings. The ridges and the material composition provide a high-friction surface from which the operator's foot will be less likely to slip off. A foot push pad 32 of EPDM rubber with ridges that are about 2 mm deep and 3 mm apart, with an apex that is about 1 mm, and an angle between two adjacent ridges that is about 60 degrees should provide a desired high-friction surface.

The foot push pad 32 should be a sufficient size to permit adequate engagement of the operator's foot for achieving the desired leverage and/or control when moving or manipulating the lift 10. A foot push pad 32 that is about 100 mm is width (the greatest dimension) and about 45 mm in length should be a sufficient size to permit adequate engagement of the operator's foot. The foot push pad 32 should also be a sufficient thickness and should resist wear. A foot push pad 32 that is about 4 mm thick should be a sufficient thickness. However, foot push pads of other size and thickness may be suitable for practicing the invention.

The principle and mode of operation of this invention have been explained and illustrated in its preferred embodiment. However, it must be understood that this invention may be practiced otherwise than as specifically explained and illustrated without departing from its spirit or scope.

1. A patient lift comprising a base and a foot push pad integrated with the base so as to remain in a fixed position relative to the base, the base having a rear end that faces the operator and a central connecting portion, the push pad being attached to the central connecting portion and at the rear end of the base, the push pad providing a high-friction surface to reduce risk that an operator's foot will slip off the base.

2. (canceled)

3. The patient lift of claim 1 wherein the foot push pad is supported by the base at an angle suitable for the operator to apply foot pressure when moving or manipulating the lift.

4. The patient lift of claim 3 wherein the angle is about 45 degrees.

5. The patient lift of claim 1 wherein the foot push pad is formed from a heavy duty material.

6. The patient lift of claim 1 wherein the foot push pad is formed from vinyl.

7. The patient lift of claim 1 wherein the foot push pad is formed from EPDM rubber.

8. The patient lift of claim 1 wherein the foot push pad has is frictional value of 0.53μ.

9. The patient lift of claim 1 wherein the foot push pad is attached to the base by at least one mechanical fastener.

10. A patient lift comprising a base and a foot push pad integrated with the base, the push pad providing a high-friction surface to reduce risk that an operator's foot will slip off the base, the foot push pad having a bottom and the mechanical fastener includes a knob extending from the bottom, the knob engaging a mating hole in the base.

11. The patient lift of claim 10 wherein each knob has a head that is at least slightly larger than the mating hole.

12. The patient lift of claim 11 wherein the head is tapered so as to be pass through the hole in one direction and defines shoulder that resists movement of the head through the hole in an opposing direction.

13. The patient lift of claim 11 wherein the knob has a stud supporting a head, wherein the stud is located between the head and the bottom of the foot push pad, the stud having a length that permits the head to hold the foot push pad tightly against the base.

14. The patient lift of claim 1 wherein the foot push pad is attached to the base by a non-mechanical fastener.

15. The patient lift of claim 14 wherein the non-mechanical fastener is an adhesive.

16. The patient lift of claim 1 wherein the foot push pad has a top finished surface.

17. The patient lift of claim 16 wherein the finished surface is a convex diamond finish.

18. The patient lift of claim 16 wherein the finished surface is ribbed to include a plurality ridges.

19. A patient lift comprising:
a base having a rear end that faces the operator and a central connecting portion; and
a foot push pad integrated with the base, the push pad being attached to the central connecting portion and at the rear end of the base so as to remain in a fixed position relative to the base, the push pad being supported by the base at an angle suitable for an operator to apply foot pressure when moving or manipulating the lift and providing a high-friction surface to reduce risk that the operator's foot will slip off the base.
